(19) United States
(12) Patent Application Publication
(10) Pub. No.: US 2018/0122260 A1
(43) Pub. Date: May 3, 2018

(54) MUSICAL PERFORMANCE EVALUATION SYSTEM AND METHOD

(71) Applicants: Samuel Speizman Walder, Oak Park, IL (US); Vishnu Indukuri, Chicago, IL (US)

(72) Inventors: Samuel Speizman Walder, Oak Park, IL (US); Vishnu Indukuri, Chicago, IL (US)

(21) Appl. No.: 15/797,347

(22) Filed: Oct. 30, 2017

Related U.S. Application Data
(60) Provisional application No. 62/414,471, filed on Oct. 28, 2016.

(51) Int. Cl. G09B 15/02; H04L 29/06; G09B 7/02

(52) U.S. Cl. CPC G09B 15/023; H04L 63/08; G09B 7/02; G10H 2220/091; G10H 2210/066; G10H 2210/071; G10H 2210/051; G10H 2210/091

(57) ABSTRACT

According to embodiments of the present invention, a musical performance evaluation method utilizes a musical composition database stored on a server containing musical encodings of all notes to be performed in a musical composition. A student user performing requested musical composition for evaluation may use a client application from a client computing device to receive audio input from the performance and compare identified frequencies to intended frequencies, and identify deviations from pitch, rhythm, and tempo throughout the performance. Deviations may be identified by switching between several pitch detection algorithms based upon a type of note (single note, chord, or plucked string) expected to be played by a student user in real time. Factors for deducting from a performance pitch score and a performance rhythm score are determined and used to calculate a performance pitch score and a performance rhythm score. Error data and scores generated may be transmitted to a server and stored in a historical session database. A student user and an instructor user may review the historical session database to determine the student's progress in musical education.

### CROSS-REFERENCE TO RELATED APPLICATIONS

The present application claims priority to the earlier filed provisional application having application No. 62414471, and hereby incorporates subject matter of the provisional application.

### BACKGROUND OF THE INVENTION

U.S. Pat. No. 9,218,748 discloses a system and method which detect characteristics of musical instrument performance by a user and provide feedback to the user. The system analyzes an audio signal from a microphone and compares this to a musical exercise. The analytical methods disclosed are limited to finding intervals and chords, and the frequency components thereof. A fundamental limitation of this method of analysis is that notes cannot be directly recognized from intervals and chords; taught instead are methods for converting intervals and chords to notes using a database through self-learning.

The prior art systems and methods do not describe the steps of a method of converting intervals and chords to notes. The prior art systems and methods, furthermore, do not provide a method for identifying notes from a musical performance without relying on data and self-learning. An approach which relies solely on data, especially crowdsourced data collected from many users, is likely to generate results based on averages, and not based on individualized performances. Moreover, an approach which relies solely on data is not suited to recognizing performances of the same musical composition at different speeds, and is not suited to acknowledging correct performances regardless of the speed of the performance.

### BRIEF SUMMARY OF THE INVENTION

Embodiments of the present invention provide a system and method for providing musical exercises for playing a stringed instrument. A system according to embodiments of the present invention includes a client computing device in communication with a server over a communication network, a microphone, a composition database hosted on the server, and a server application hosted on the server. The client computing device may be a personal computing device such as a smartphone or a portable computer. A client application may be stored on the client computing device.

A composition database according to embodiments of the present invention may store a composition data structure, which may in turn store data records which define a musical composition.

### BRIEF DESCRIPTION OF THE DRAWINGS

FIG. 1 illustrates a diagram of a musical performance evaluation system according to embodiments of the present invention.

FIG. 2 illustrates a frequency recognition method according to embodiments of the present invention.

FIG. 3 illustrates a musical performance evaluation method according to embodiments of the present invention.

FIG. 4 illustrates an onset detection method according to embodiments of the present invention.

FIG. 5 illustrates a rhythm score detection method according to embodiments of the present invention.

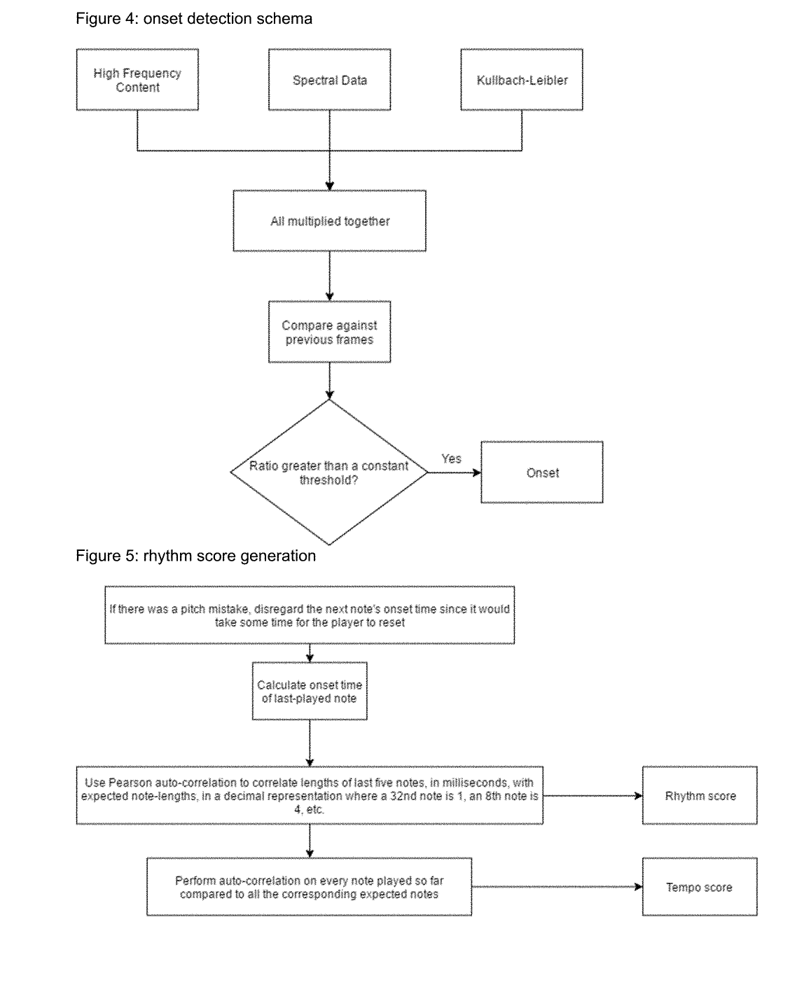

FIG. 6 illustrates a musical composition user interface according to embodiments of the present invention.

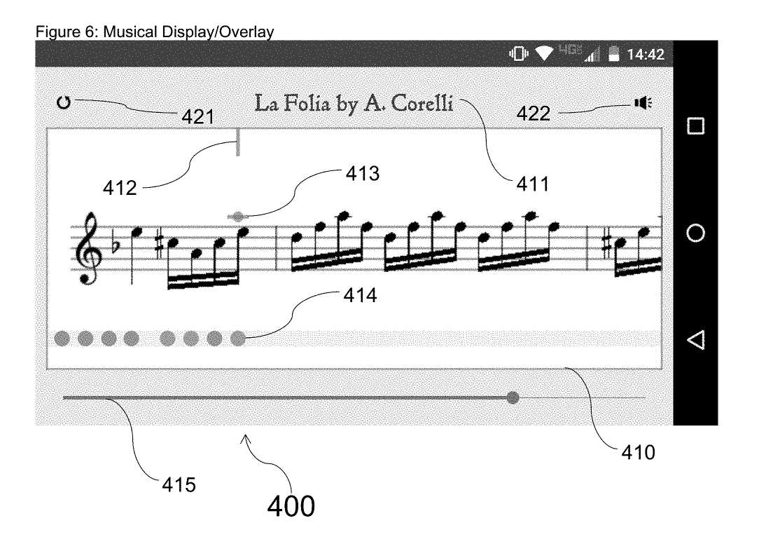

FIGS. 7A and 7B illustrate a musical composition search user interface according to embodiments of the present invention.

FIGS. 8A and 8B illustrate phrase practice user interfaces according to embodiments of the present invention.

FIGS. 9A and 9B illustrate performance score user interfaces according to embodiments of the present invention.

### DETAILED DESCRIPTION OF THE INVENTION

One or more of the embodiments of the present invention provide a musical performance evaluation system and methods for the use thereof. Embodiments of the present invention may be operated in conjunction with a server connected to a communication network, and at least one computing device connected to a communication network.

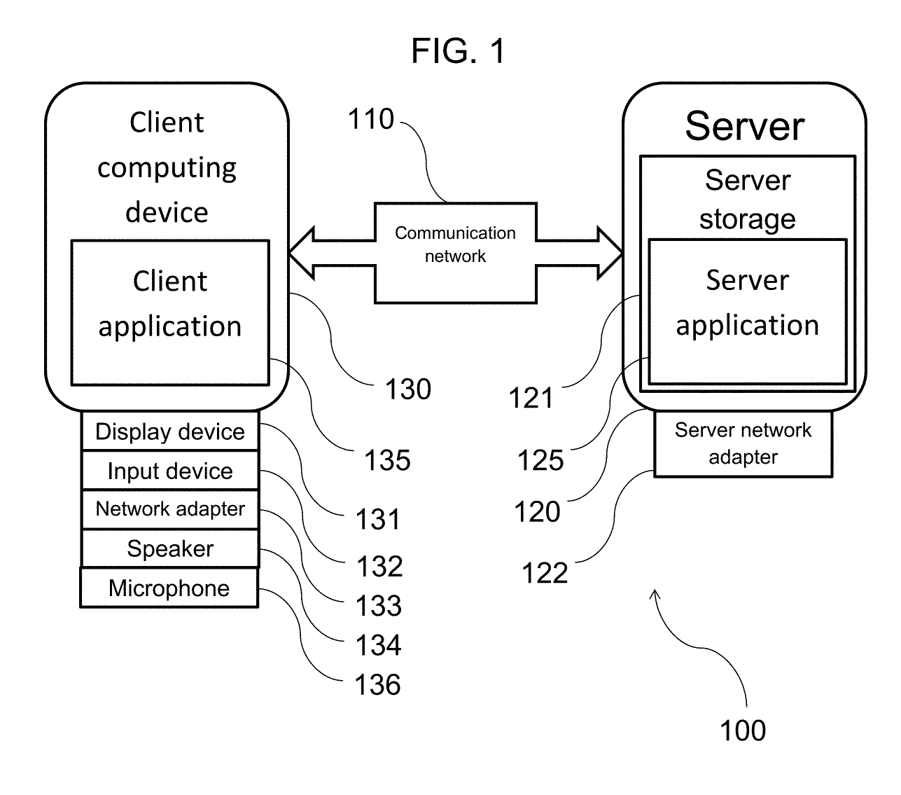

FIG. 1 illustrates a diagram of a musical performance evaluation system 100 according to embodiments of the present invention. The musical performance evaluation system 100 includes a communication network 110, a server 120, and at least one client computing device 130 in communication with the server 120 over the communication network 110. A microphone 136 may be in communication with the client computing device 130, and may be removably connected to the client computing device 130 or may be an integral component of the client computing device 130. A speaker 134 may be in communication with the client computing device 130, and may be removably connected to the client computing device 130 or may be an integral component of the client computing device 130. A musical composition database 200 may be stored on a server 120. A historical session database 250 may be stored on a server 120.

The communication network 110 may be any global or local communication network that provides a communication protocol for computers and servers having network communication adapters. For example, the communication network 110 may be the Internet, a local area network, or other similar networks known to persons of ordinary skill in the art.

The server 120 may include a server storage 121 and a server network adapter 122. The server storage 121 may be any kind of electronic storage device suitable for recording databases, such as magnetic, solid-state, or other similar storage devices known to persons of ordinary skill in the art. The server network adapter 122 may be any hardware peripheral known to persons of ordinary skills in the art for communicating by a wired connection or a wireless connection between a device and a communication network 110.

A server application 125 may be hosted on the server 120. The server application 125 may write data to the server storage 121 and retrieve data from the server storage 121. The server application 125 may receive queries or commands from the client computing device 130.

The client computing device 130 may be a portable computer. For example, the client computing device 130 may be a mobile smartphone, mobile tablet, or any of other mobile devices known to persons of ordinary skill in the art. The client computing device 130 may be a laptop computer. The client computing device 130 may be a desktop computer. The client computing device 130 may be any among further computing devices known to persons of ordinary skill in the art.

The client computing device 130 may include a display device 131, an input device 132, and a network adapter 133. The display device 131 may be an optical device that displays an image for a human user, such as an LCD display or other similar displays known to persons of ordinary skill in the art. The input device 132 may be an input device for a mobile computer, such as a touch-sensitive screen incorporated into the display device, or a stylus pointing device for use with a touch-sensitive screen. The input device 132 may be an input device for a desktop or laptop computer, such as a keyboard or a mouse. The network adapter 133 may be any hardware peripheral known to persons of ordinary skills in the art for communicating by a wired connection or a wireless connection between a device and a communication network 110.

A client application 135 may be stored on the client computing device 130. According to embodiments of the present invention, while a client computing device 130 accesses the server 120, a server application 125 hosted on a server storage 121 may transmit a composition data structure to the client computing device 130 for rendering in a client application 135. The client application 135 may render a user interface for display on the display device 131. The user interface may display data records of a composition data structure. The input device 132 may be used by a human operator to input queries or commands through the client computing device 130 to the server 120.

While a server application 125 transmits a composition data structure to the client computing device 130, the server application 125 may refresh the display of the user interface so as to update data records displayed on the user interface. A refresh of the display of the user interface may occur in real-time to indicate, for example, an update on the server 120 to data records displayed on the user interface. More than one client computing device 130 may access the server 120 simultaneously. While more than one client computing device 130 is accessing the server, and while a server application transmits a composition data structure to each client computing device 130 accessing the server, the server application 125 may refresh the display of the user interface for each client computing device 130 so as to indicate an update on the server 120 to data records displayed on each user interface.

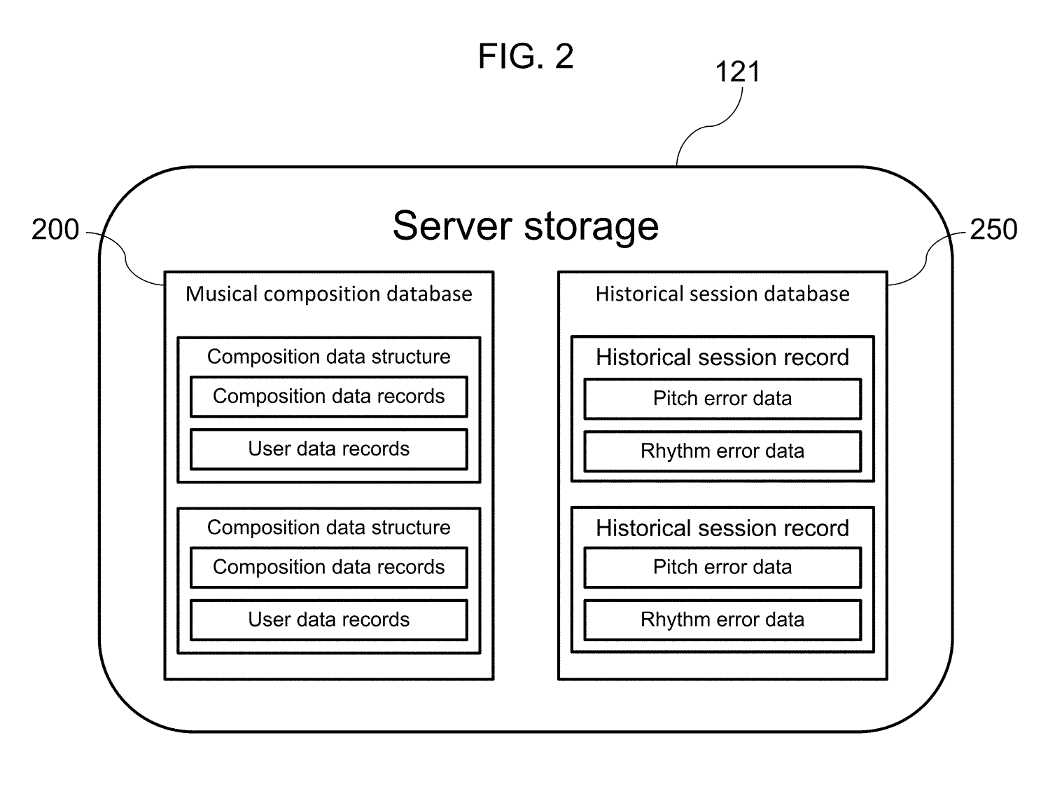

FIG. 2 illustrates the contents of a musical composition database 200 which may be stored on a server storage 121, according to embodiments of the present invention. A musical composition database 200 according to embodiments of the present invention may store a composition data structure 210. A composition data structure 210 may store data records and data structures that define a musical composition.

A composition data structure 210 may include a plurality of composition data records. According to embodiments of the present invention, a composition data record included in a composition data structure 210 may be any of the following data records:

A title record;

A composer record;

A frequencies list;

A note lengths list;

A key changes list;

A time signature changes list;

A musical encoding.

A musical encoding may be composed of a list of notes to be played in a musical composition, which may be transcribed from a written copy of a musical composition such as sheet music. A frequencies list, a note lengths list, a key changes list, and a time signature changes list may each be derived from a musical encoding by a scripted program embodying known principles of musical analysis.

For example, in accordance with an embodiment of the present invention, MusicXML is an open-source musical notation. A musical composition may be notated in MusicXML. The notation of the musical composition may be parsed by a Python script to determine what the expected pitches, rhythms, key signatures, and time signatures are. The script may also modify the MusicXML notation and instruct the client computing device 130 to upload to the server 120 the parsed and modified MusicXML notation, along with data records associated with the musical composition (pitches, rhythms, key signatures, time signatures).

In accordance with another embodiment of the present invention, a client application 135 program may parse a musical encoding of a musical composition from an image of musical notation, such as a photograph of sheet music, by known principles of machine vision.

A composition data structure 210 may further include user data records associated with a user. User data records included in a composition data structure 210 may be any of the following data records:

A username;

A performed status;

A performance count;

Recordings of the user performing a musical composition;

An average performance score.

Each user data record may be associated with a student user.

According to embodiments of the present invention, queries or commands initiated by a human operator from the client computing device 130 to the server 120 may be received by the client application 135 and transmitted to the server application 125. The queries or commands may be interpreted by the server application 125, which may then perform operations on the musical composition database 200.

According to embodiments of the present invention, a user may create a user account for the client application 135. A user account may be stored by the server 120. A user may enter authentication credentials into the client application 135 using the input device 132 to identify the user to the client application 135. A user database recorded on the server storage 121 may include a user data structure which holds a user's authentication credentials, including a username and a password. According to embodiments of the present invention, a user may be a student or an instructor. A user data structure may include a status record identifying the user as a student or an instructor.

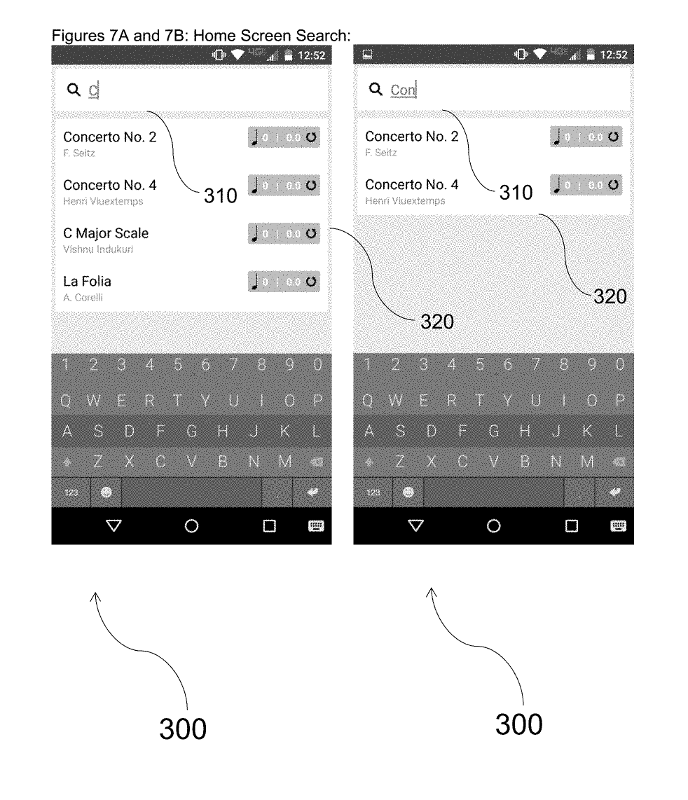

FIGS. 7A and 7B illustrate a musical composition search user interface 300 which a client application 135 may render on the display device 131. The musical composition search user interface 300 includes a search field 310 and a search result list 320.

According to embodiments of the present invention, a user may desire to view a visual representation of a composition data structure stored in the musical composition database 200 and may desire to perform the musical composition represented by the composition data structure to obtain an evaluation of the user's performance by the musical performance evaluation system 100. A user may run the client application 135 on a client computing device 130 to select a desired musical composition from a musical composition database 200. The user may enter a search term into the search field 310 using the input device 132 to identify the title of the desired musical composition to the client application 135. In response, the client application 135 may query the server application 125 using the search term entered and the username of the authenticated user.

The server application 125 may run a search algorithm to match the search term entered against the title records of each composition data structure 210 generate a search result list 320. Such search algorithms are generally known in the art. A search result list 320 may be a list of each composition data structure 210 found having a title record matching the search term entered. The server application 125 may transmit the search result list 320 and the user data structure of the authenticated user to the client application 135. A search algorithm may be an incremental search algorithm as known in the art which enables the server application 125 to progressively generate and return updated search result lists 320 multiple times while the user is entering the search term in real-time.

Upon receiving a search result list 320, the client application 135 may display the search result list 320 on the musical composition search user interface 300. The search result list 320 may list the title record of each composition data structure 210 in the search result list 320. If a composition data structure 210 has a played status of “played” associated with the authenticated user, the search result list 320 may additionally list the performance count associated with the authenticated user and the average performance score associated with the authenticated user for that composition data structure 210.

An authenticated user may interact with the search result list 320 to select a composition data structure 210 listed in the search result list 320 to request a musical composition to be transmitted to the client computing device 130 for evaluation of a performance of the requested musical composition. In response, the server application 125 may submit the composition data structure 210 representing the selected musical composition to the client computing device 130, whereupon the client application 135 may receive the composition data structure 210, display a phrase practice user interface 400 on the display device 131, and render elements of the composition data structure 210 on the phrase practice user interface 400.

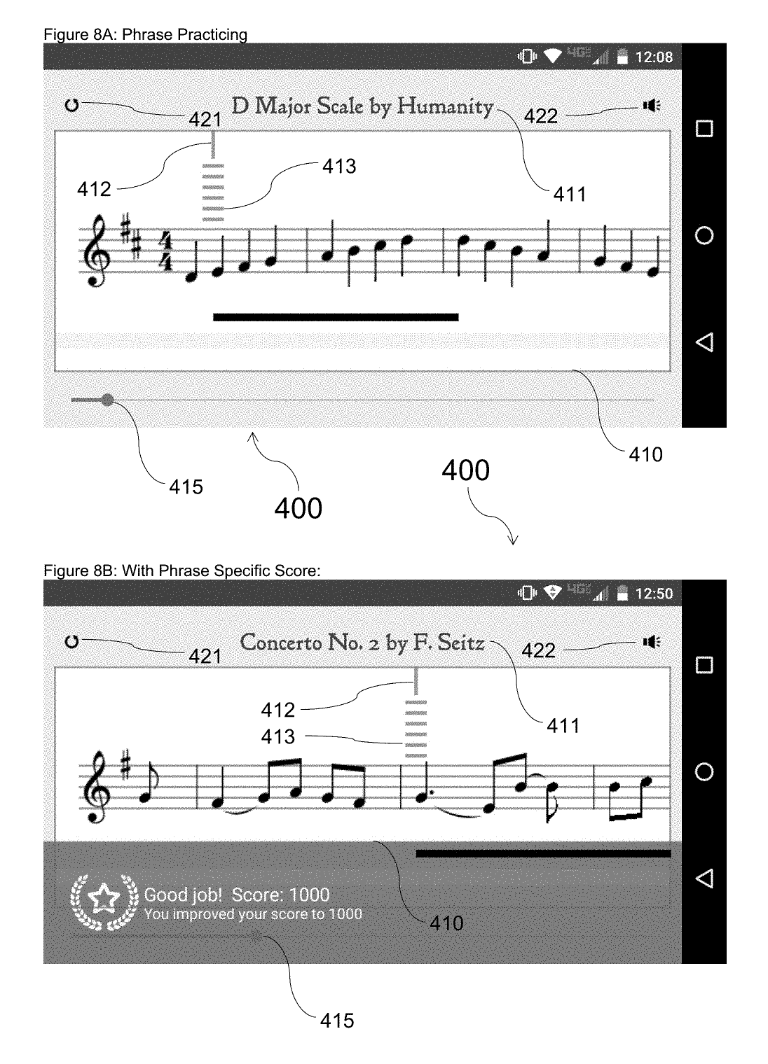

FIGS. 8A and 8B illustrate a phrase practice user interface 400 which a client application 135 may display on the display device 131. The phrase practice user interface 400 includes a composition musical notation display 410, a composition title display 411, a note indicator 412, a floating note 413, a performance evaluation representation 414, a scroll bar 415, a reset control 421, and an audio control 422.

A composition musical notation display 410 may be a representation of a musical encoding of a composition data structure 210 stored in a musical composition database 200. To represent a musical encoding, a composition musical notation display 410 may be rendered by the client application 135 in accordance with the representation of the musical encoding in any conventional musical notation, such as a musical staff. The representation of the musical encoding may be displayed in a format suitable for scrolling along a single axis, such as a single continuous musical staff. A composition musical notation display 410 may enclose a segment along the representation of the musical encoding; the rest of the representation of the musical encoding may be truncated by the edges of the composition musical notation display 410. The scroll bar 415 may be manipulated by the input device 132 to scroll the representation of the musical encoding through the composition musical notation display 410 such that the composition musical notation display 410 encloses different segments along the representation of the musical encoding.

A composition title display 411 may be a text display of the title element of the composition data structure 210.

A note indicator 412 may be a marker having a variable position along the representation of the musical encoding. A note indicator 412 may be located at a position along the representation of the musical encoding corresponding to the location of a next note for performance in the representation of the musical encoding (as described below). A note indicator 412 may be relocated along the representation of the musical encoding if the next note for performance advances, or if the representation of the musical encoding is scrolled such that the next note for performance is at a different location in the composition musical notation display 410. The note indicator 412 may be hidden if the representation of the musical encoding is scrolled such that the next note for performance is not enclosed within the composition musical notation display 410.

A floating note 413 may be a marker overlaid on the representation of the musical encoding. The floating note 413 may be overlaid proximate to the representation of the next note for performance in the representation of the musical encoding. Upon a student user performing the next note for performance and the client application 135 identifying a frequency associated with the played note (as described below), the floating note 413 may be moved in the representation of the musical encoding to reflect the identified frequency associated with the played note, to indicate the frequency at which the student user was determined to have performed the played note. The floating note 413 may then be moved to be overlaid over the subsequent next note for performance.

A performance evaluation representation 414 may, upon the student user performing each note of the musical encoding, display a performance evaluator corresponding to that note paralleling that note's location in the representation of the musical encoding. A note displayed by the performance evaluation representation 414 may display in a first color indicating correct performance, or may display in a second color indicating incorrect performance, depending on whether the student user's performance of each note so far has been correct or incorrect. The first color and the second color may be chosen to be visually distinguishable by color-blind persons.

While a client application 135 displays a phrase practice user interface 400, a user may manipulate the input device 132 to toggle the client application 135 to displaying a current score user interface 500 or a historical score user interface 550.

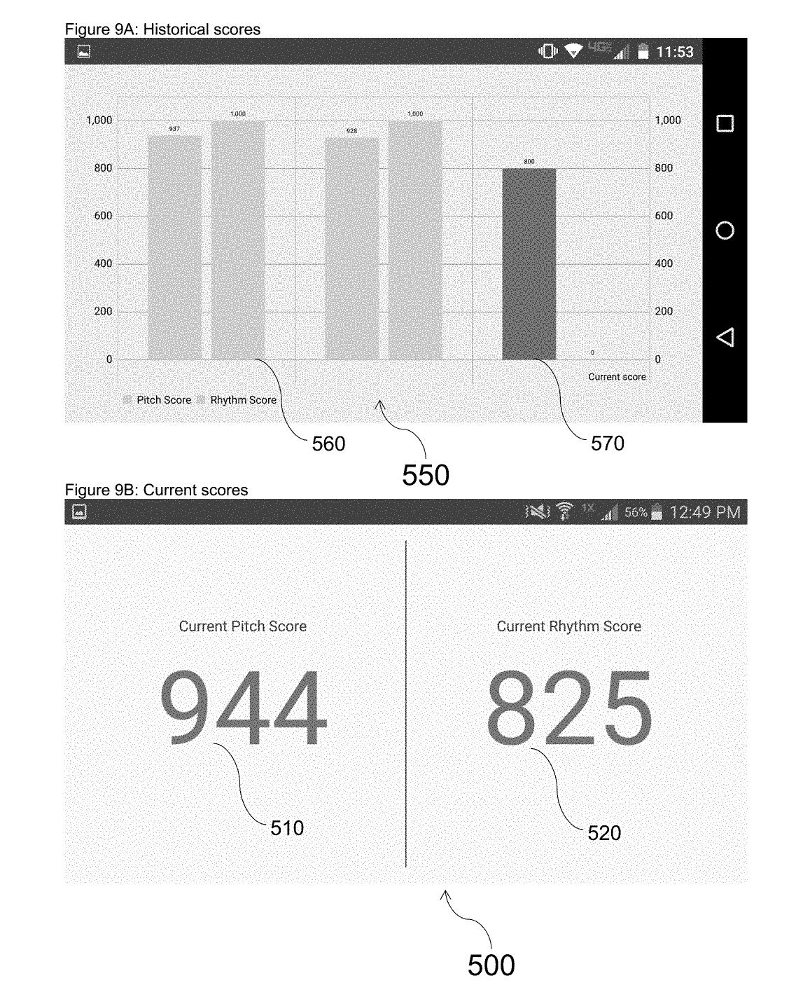

FIGS. 9A and 9B illustrate a current score user interface 500 and a historical score user interface 550 which a client application 135 may display on the display device 131. The current score user interface 500 includes a current pitch score display 510 and a current rhythm score display 520. The historical score user interface 550 includes a past score display 560 and a current score display 570.

A musical performance evaluation method according to embodiments of the present invention may proceed as follows. In a first step of the musical performance evaluation method, a student user may access the client computer running the client application by entering authentication credentials into the client application 135 using the input device 132 to identify the student user to the client application 135.

In a next step of the musical performance evaluation method, the student user accesses the musical composition search user interface 300 and may select a desired musical composition from a musical composition database 200 to request a musical composition to be transmitted to the client computing device 130 for evaluation of a performance of the requested musical composition. The user may select a desired musical composition from a list displayed on the musical composition search user interface 300 by default, or may select a desired musical composition from a search result list 320 displayed on the musical composition search user interface 300 as a result of entering a search term into the search field 310 using the input device 132.

In a next step of the musical performance evaluation method, the student user accesses a phrase practice user interface 400 on which the client application 135 renders elements of the composition data structure 210 representing the requested musical composition selected by the student user. The phrase practice user interface 400 may display a representation of a musical encoding of the composition data structure 210, which may be scrolled such that the composition musical notation display 410 encloses a starting segment along the representation of the musical encoding. The client application 135 may query the server 120 to determine whether the requested musical composition has associated pitch error data or associated rhythm error data stored in the historical session database 250 in association with the student user. If so, the associated pitch error data or associated rhythm error data may be summarized on the phrase practice user interface 400.

In an optional step of the musical performance evaluation method that may be performed at any time henceforth until the final step of the musical performance evaluation method, the student user may use the input device 132 to highlight a portion along the length of the representation of the musical encoding. In response, the client application 135 may set itself to run in a phrase mode, and may set the notes of the musical encoding that fall along the highlighted portion of the representation of the musical encoding as a target phrase.

In a next step of the musical performance evaluation method, the client application 135 may set up musical evaluation parameters for a performance of the requested musical composition by the student user. The client application 135 may create and track a next note for performance variable, which may track the next note of the requested musical composition which the client application 135 expects to receive through a microphone 136 at any particular time. The client application 135 may create and track a performance pitch score variable and a performance rhythm score variable, each of which may be a number having a lower threshold and an upper threshold. According to embodiments of the present invention, the lower threshold may be 0 and the upper threshold may be 1000. The client application 135 may parse the musical encoding to generate and store an expected note length value corresponding to each note of the musical encoding. Expected note length values may be stored in a data structure such as an array.

Initially, the next note for performance may be set to the first note of the entire musical encoding. When the client application 135 starts running in phrase mode, the next note for performance may be set to the first note of the target phrase. At any time, the student user may operate the reset control 421 to reset the next note for performance to the first note of the target phrase if the client application 135 is running in phrase mode, or otherwise to the first note of the entire musical encoding.

In a next step of the musical performance evaluation method, the client application 135 may then receive audio input through a microphone 136 in communication with the client computing device 130. The student user may generate the received audio input by attempting to perform the requested musical composition on a stringed instrument within the audio capture range of the microphone 136. At any time, the student user may operate the audio control 422 to begin playing a rendition of the musical encoding over the speaker 134 starting from the next note for performance. The rendition of the musical encoding may be synthesized from expected note length values and from frequencies of each note of the musical encoding. The rendition of the musical encoding may be made up of, for each note of the musical encoding, an additive synthesis of sine tones having a length corresponding to that note and a pitch corresponding to that note. The rendition of the musical encoding may play until the end of the target phrase if the client application 135 is running in phrase mode, or may play until the end of the musical encoding otherwise.

Upon receiving audio input through a microphone 136, the client application 135 may identify a played note from the audio input by correlating the audio input to the next note for performance. The client application 135 may identify a frequency associated with the played note from the audio input and may identify a note onset time associated with the played note from the audio input. The client application 135 may identify a frequency from the audio input by the cepstral method of frequency recognition as illustrated in FIG. 2. The client application may also identify whether the user has played a chord correctly (multiple notes at once).

Identifying whether a chord has been played correctly may be accomplished by, for example, calculating a salience for each frequency bin of the FFT, choosing the highest salience frequency as one of the played frequencies, then iteratively canceling out that frequency's effects on the spectral envelope to calculate the next highest salience frequency, and so on for an expected number of fundamental frequencies.

In accordance with embodiments of the present invention, the cepstral method depends on the harmonic profile of a stringed instrument such as a violin, and the harmonic profile of strings being played with a rosined bow. A note is produced on the violin by pulling a rosined bow against one or more strings. The bow sticks and slips as it is pulled across at the exact frequency at which the violin resonates. This means there is almost no inharmonicity, meaning that overtones of a fundamental frequency played on the bowed violin will be integer multiples of the fundamental. To determine which note is being played, the client application 135 may window using the Hann function and then take a fast Fourier transform (FFT) on each 2048 samples of live audio data being sampled at 44.1 kHz by the microphone 136. The client application 135 may use sliding window with a hop size of 1024 samples, speeding up computation and accuracy. The client application 135 may then determine the natural log of the magnitude of each frequency bin. The client application 135 may then perform an inverse FFT on that data, and isolate the top 10 bins with the greatest amplitude of the result. After a small numerical manipulation, the bin of the largest magnitude corresponds to the determination of the fundamental frequency of the audio input.

Chords may be identified by analyzing the magnitude-sorted top ten cepstral bins are when a chord is expected to be performed in accordance with the musical encoding. The frequencies corresponding to each bin are compared against the expected notes in the chord.

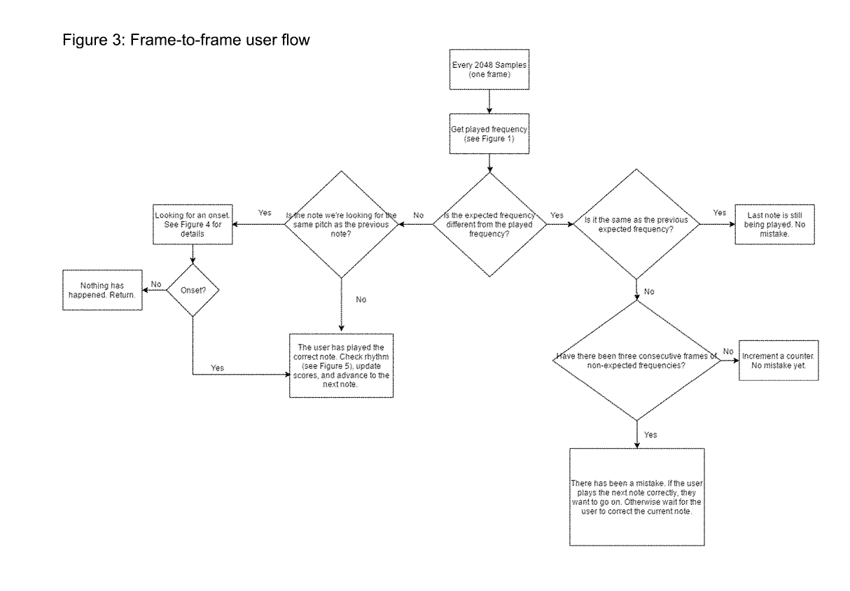

The client application 135 may identify a note onset time from the audio input by the onset detection method as illustrated in FIG. 4. The client application 135 may use the multiplicative product of three algorithms, run every frame (2048 audio samples), to generate a number which corresponds to the likelihood there has been a new note played. Note onset times determined may be stored in a data structure such as an array. For each note onset time, a note offset time for that note may be determined by the value of the note onset time plus 1. For each note onset time determined, the client application 135 may calculate a played note length associated with the played note. Played note lengths calculated may be stored in a data structure such as an array.

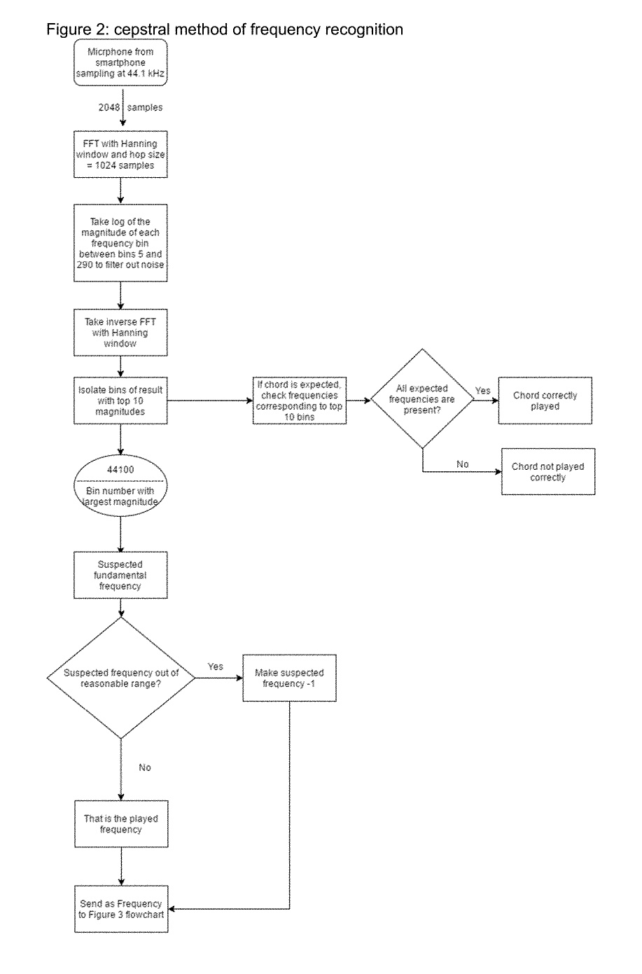

Upon identifying a frequency, the client application 135 may calculate a performance pitch score. The client application 135 may compare the identified frequency associated with the played note with the intended frequency of the played note as encoded in the musical encoding. FIG. 3 illustrates a method for comparing the identified frequency with the intended frequency. Such a comparison may determine a factor for deducting from a performance pitch score based on the frequency of a played note not matching the intended frequency of the played note. A performance pitch score may be calculated by scaling, to the numerical range of the lower threshold and the upper threshold, the percentage of played notes among all notes in the musical encoding where, on initial performance, the identified frequency matches the intended frequency of the played note.

A mismatch between the identified frequency and the intended frequency may cause the client application 135 to record the mismatch as pitch error data associated with the student user. The client application 135 may transmit the pitch error data to the server 120 for storage in association with the requested musical composition in a historical session database 250. The pitch error data may then be compared to prior pitch error data stored in the historical session database 250 in association with the requested musical composition. If the pitch error data has recurred in the historical session database 250 in association with the requested musical composition, the pitch error data may be summarized on the phrase practice user interface 400 while the student user continues to perform the requested musical composition.

Upon calculating a played note length, the client application 135 may calculate a performance rhythm score. A performance rhythm score may be calculated by comparing played note lengths to note lengths encoded by the musical composition. Note length comparisons for all played notes may be performed against all notes in the musical encodings.

A note length comparison may be a comparison of a played note length associated with a played note with the expected note length associated with the same note by Pearson autocorrelation. The result of comparing a played note length with an expected note length by Pearson autocorrelation may represent a degree of correlation ranging from a negative correlation to a positive correlation. A negative correlation may be represented by a result of −1; non-correlation may be represented by a result of 0; a positive correlation may be represented by a result of 1; and intermediate values between these values may represent degrees of positive and negative correlation.

Performing note length comparisons for five consecutive played notes may determine a factor for deducting from a performance rhythm score based on a played note being off-rhythm in relation to other played notes. Consequently, deductions from a performance rhythm score may be based on the relative rhythm of played notes to each other while ignoring the absolute value of the rhythm of the student user's performance.

Performing note length comparisons for all played notes may determine a factor for deducting from a performance rhythm score based on unintended changes in tempo throughout the student user's performance. Consequently, deductions from a performance rhythm score may be based on the consistency of the tempo of the student user's performance throughout, rather than the absolute tempo of the student user's performance. These two criteria for deducting a performance rhythm score may permit the student user to perform the requested musical composition at any speed without impacting the performance rhythm score.

A deviation in rhythm or a deviation in tempo may cause the client application 135 to record the deviation as rhythm error data associated with the student user. The client application 135 may transmit the rhythm error data to the server 120 for storage in a historical session database 250 in association with the requested musical composition. The rhythm error data may then be compared to prior rhythm error data stored in the historical session database 250 in association with the requested musical composition. If the rhythm error data has recurred in the historical session database 250 in association with the requested musical composition, the rhythm error data may be summarized on the phrase practice user interface 400 while the student user continues to perform the requested musical composition.

The client application 135 may store the calculated performance pitch score and the calculated performance rhythm score. The client application 135 may periodically recalculate the performance pitch score and the performance rhythm score for each played note identified from the audio input. The current score user interface 500 may display the stored performance pitch score at the current pitch score display 510, and may display the stored performance rhythm score at the current rhythm score display 520. The historical score user interface 550 may display the stored performance pitch score and the stored performance rhythm score at the current score display 570.

In a next step of the musical performance evaluation method, if the identified frequency associated with the played note does not match the intended frequency of the played note as encoded in the musical encoding, the client application 135 may not advance the next note for performance to the subsequent note in the musical encoding. Instead, the client application 135 may continue to correlate audio input to the current next note for performance. Furthermore, the client application 135 may record the played note as initially incorrectly performed.

If the identified frequency associated with the played note does match the intended frequency of the played note as encoded in the musical encoding, the client application 135 may advance the next note for performance to the subsequent note in the musical encoding. The client application 135 may begin to correlate audio input to the subsequent next note for performance. Furthermore, if the played note has not been recorded as initially incorrectly performed, the client application 135 may record the played note as initially correctly performed.

In a next step of the musical performance evaluation method, after the client application 135 has matched the intended frequency of a played note with the intended frequency of the final note encoded in the musical encoding, the client application 135 may stop receiving audio input and may calculate the final values for the performance pitch score and the performance rhythm score. The client application 135 may record these final values as historical values associated with the requested musical composition for the student user. Each historical value of a performance pitch score and a performance rhythm score may be displayed by the historical score user interface 550 on the past score display 560. Historical values may be transmitted by the client application 135 to the server 120, and stored in the historical session database 250 in a historical session record associated with the student user that performed the requested musical composition. Pitch error data, rhythm error data, performance pitch score, and performance rhythm score for the student user's performance of the requested musical composition may be summarized and displayed.

An instructor user interface according to embodiments of the present invention may be accessed by an instructor user through an instructor edition of the client application 135. The user database stored on the server 120 may store instructor credentials which associate an instructor user with authorization to view contents of the historical session database 250 associated with particular student users. The instructor user interface may display statistics regarding pitch error data and rhythm error data associated with particular student users stored in the historical session database 250. The instructor user interface may enable playback of recordings of performance frequency errors or performance rhythm errors associated with particular student users stored in the historical session database 250.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A musical performance evaluation method, comprising:
authenticating a student user accessing a client application from a client computing device in communication with a server;
in response to a command from the client computing device, transmitting a composition data structure representing a requested musical composition to the client computing device for evaluation of a performance of the requested musical composition;
in response to a command from the client computing device, displaying a representation of a musical encoding of the composition data structure on a composition musical notation display, which may be scrolled such that the composition musical notation display encloses a segment along the representation of the musical encoding;
storing an intended note frequency and an expected note length value corresponding to each note of the musical encoding;
tracking a next note for performance variable, a performance pitch score variable, and a performance rhythm score variable;
receiving audio input through a microphone in communication with the client computing device;
identifying a played note from the audio input by correlating the audio input to the next note for performance;
determine a factor for deducting from a performance pitch score based on the frequency of a played note not matching an intended frequency of the played note;
determining a factor for deducting from a performance rhythm score based on a played note being off-rhythm in relation to other played notes, and determining a factor for deducting from a performance rhythm score based on unintended changes in tempo throughout the student user's performance;
determining whether to advance the next note for performance based on whether the frequency of a played note matches an intended frequency of the played note; and
calculating final values for the performance pitch score and the performance rhythm score.

2. A non-transitory computer-readable medium, comprising:
a musical composition database comprising a plurality of composition data structures, each including a musical encoding comprising a list of notes to be played in a musical composition; and a performance score associated with a user; and
a historical session database comprising a plurality of performance pitch errors and a plurality of performance rhythm errors each associated with a composition data structure and a user.
